(19) United States
(12) Patent Application Publication
(10) Pub. No.: US 2003/0088436 A1
(43) Pub. Date: May 8, 2003

(54) System for management of information flow in automotive dealerships

(76) Inventors: Lenard J. Berger, Oakton, VA (US); Salvatore F. D'Ambra, Blue Ridge Summit, PA (US)

Correspondence Address: HALE AND DORR LLP, 300 PARK AVENUE, NEW YORK, NY, 10022, US

(21) Appl. No.: 10/267,371

(22) Filed: Oct. 9, 2002

Related U.S. Application Data
(60) Provisional application No. 60/328,015, filed on Oct. 9, 2001.

(51) Int. Cl. G06F 17/60

(52) U.S. Cl. 705/1

(57) ABSTRACT

A system and method for gathering and managing information about a company's customers and potential customers at the point of customer contact with the company and analyzing the information for service and product selling opportunities and for managing the employees of a company. The system and method of the present invention utilizes a wireless device to capture customer information at the point of customer contact. The information once captured is processed and compared against other database records to mine service and product selling opportunities to present to the customer. The mined service and product selling opportunities are presented in real time to the customer through the wireless device. The customer data once captured has tasks associated with it that provide additional selling opportunities. The collected customer data also allows management to monitor the performance of employees relative to each other as well as mine successful selling strategies from the employees with the best performance. The system and method of the present invention is described as an application for an automotive dealership.

### CROSS REFERENCE TO RELATED APPLICATION

Priority is herewith claimed under 35 U.S.C. §119(e) from Provisional Patent Application No. 60/328,015, filed Oct. 9, 2001, which is incorporated by reference in its entirety.

### BACKGROUND OF THE INVENTION

Companies receive information on their customers and/or potential customers from many input channels. The information channels are often disparate. Information carried by certain channels is more readily capturable than that carried by other channels. For example, customer information obtained when a customer visits a company's web site and completes a survey or by the company tracking in a web log a customer's browsing habits while on the company's site is more readily capturable than customer data obtained through a face-to-face meeting between a customer and a company employee on a company's showroom floor. As a result of the disparate input channels, which are often times large in number, it is difficult for a company to adequately capture incoming customer and/or potential customer information.

Aside from the difficulty associated with capturing customer and/or potential customer information there also exists a difficulty associated with how to manage and use the customer and/or potential customer information once it has been captured. Presently, companies may have a separate system for capturing customer information from each of their customer information channels. Further, these separate systems are often not compatible with one another.

The company that is able to capture information from their customer information channels and manage the information in a manner that allows the mining out of selling opportunities is the company that will succeed, no matter what market segment they compete in and irrespective of whether they sell services or goods.

One of the most significant customer information channels is through a company's employees and/or agents and, in particular, a company's sales force. The capture of customer information and mining that same information for selling opportunities is only part of the solution. The information has to put in the hands of a company's employees and/or agents so that they can use it to quickly and efficiently meet customer needs. Moreover, allowing a company's employees and/or agents to capture customer information where they have first contact with the customer also allows a company to capture and manage information regarding its employees and/or agents. For example, capturing customer information from a highly productive employee and/or agent may allow the company to understand the key elements to high productivity and use this information to train their other employees and/or agents.

A number of barriers currently exist that prevent customer information from being captured and used efficiently. An example of one such barrier exists in the form of missed opportunities for capturing customer and/or potential customer information. Such opportunities arise, for example, during person-to-person contact between a potential customer and a company employee and/or agent, such as customer contact with a salesperson on a company's showroom floor. In such a setting there is often a very narrow window of opportunity to capture critical information pertaining to the potential customer. There exists a need for the quick collection of information at the point of customer contact. The data collection cannot be an onerous burden on a customer otherwise the customer may quickly become frustrated or leave for another vendor or service provider. Nor can the data capture be too onerous for a company's employees and/or agents; otherwise the company will not have complete compliance by their employees and/or agents. If the customer does not provide information directly the company employee or agents has to be able to quickly recall their interaction and impressions regarding the customer and record the information. A salesperson's thoughts most accurately reflect the actual customer interaction at or near the time of the actual interaction.

A further problem exists with current customer information collection methods in that they require at least one transcription step. Customer information can be captured at the point of customer contact using a clipboard and pre-printed forms. However, for the information to be placed in a database so the data can be aggregated and mined for intelligence requires a transcription step of entering the information from the form into a database. This intervening step provides significant opportunity to have information enter incorrectly. The intervening step also presents a disincentive to the company's employees and/or agents to enter the data. Moreover, the forms can be lost before the data is entered into a database. Furthermore, due to the latency between when the data is collected and then entered the database never reflects the actual customer population.

Additionally, there exists a need to provide information to a company's employees and/or agents at the point of customer contact in order to provide them additional selling opportunities. These opportunities are often frustrated due to the disparate systems that collect customer information and the fact that often times these systems are not able to share information, requiring an employee and/or agent to check multiple databases.

Further, if a company is able to capture customer information in a usable manner there is often a gap in the time between when the information is collected and when and where the company and/or the company's employees and/or agent can use the information. Therefore, there currently exists a need to provide the information captured from customer interaction and intelligence mined from the information to a company and/or a company's employees and/or agents to aid a customer in the buying process and/or present selling opportunities to a customer in a timely manner.

One example where the above problems exist is that of an automotive dealership. An automotive dealership has several information input channels including, for example, customers who arrive on a dealership's showroom floor to look at new cars, customers who phone in questions to the dealership regarding new car inventory and prices for a particular car make and model, and customers of the dealership's service center and/or body shop. There exists a need to collect customer information from these and other channels and provide that information to the dealership's employees and/or agents in a usable format so they can quickly and efficiently address customer needs.

### SUMMARY OF THE INVENTION

The present invention provides a system and a method for capturing customer or potential customer information, managing the captured information, and using the captured information for selling opportunities and the management of a company's employees and/or agents.

The system and method of the present invention uses a wireless device to collect customer or potential customer information at the point of customer contact with the company. The collected customer information allows the sales process to be sped up. The wireless device also allows a company to access in real time information that aids in the sales process.

The system and method of the present invention also employs a wireless device to collect data about a company's employees and/or agents by monitoring in real time their activity. Such monitoring activities include, for example, monitoring whether a customer is being handled within a company's defined parameters and whether a customer has arrived for a scheduled appointment.

The present invention provides a system for managing an automotive dealership, wherein the interactions between an automotive dealership and a customer or potential customer are captured with a wireless device at the point of customer contact with the automotive dealership. The system comprises a wireless device capable of doing at least one of receiving customer data at the point of customer contact, sending a query to a database, and displaying at least one of received customer data, processed customer data, or queried data from a database; and a processing device for processing tasks in response to customer data.

Another embodiment of the present invention provides a method for managing an automotive dealership using a wireless device to capture interactions between the automotive dealership and a customer. The method comprises collecting customer data with a wireless device at the point of customer contact, storing customer data in a database, sending a query to a database from the wireless device, displaying on the wireless device at least one of customer data received at the point of customer contact, processed customer data, queried data from at least one database, managing captured customer information from said wireless device; and processing tasks in response to customer data.

A further embodiment of the present invention provides a method for managing an automotive dealership comprising receiving customer data from a wireless device, storing customer data in a database, processing customer data with a rules engine, mining the customer data for selling opportunities; and sending at least one selling opportunity to the wireless device.

Yet another embodiment of the present invention provides a method for managing the productivity of at least one an employee or an agent of an automotive dealership. The method comprises receiving customer data originating from at least one employee or agent of the automotive dealership from a wireless device operated by the at least one employee or agent at the point of customer contact with the automotive dealership; aggregating customer data received from at least one employee or agent into a data array, wherein said at least one data array comprises at least one field conveying in real time a performance metric.

### BRIEF DESCRIPTION OF THE DRAWINGS

FIG. 1 illustrates an embodiment of a system network architecture in accordance with the invention.

FIG. 2 illustrates an embodiment of a system hardware architecture in accordance with the invention.

FIG. 3 illustrates an embodiment of a system architecture in accordance with the invention.

FIG. 4 illustrates an embodiment of a wireless device that can be used in accordance with the invention.

FIG. 5 illustrates an embodiment of a permissions control of a system in accordance with the invention.

FIGS. 6A-6D illustrate embodiments of data paths in accordance with the invention.

FIG. 7 illustrates a flow chart of a rules engine for scheduling and executing tasks in accordance with the invention.

FIG. 8 illustrates a flow chart of an application flow in accordance with the invention.

FIG. 9 illustrates a flow chart of a trigger process in accordance with the invention.

FIG. 10 illustrates a flow chart of a report generation process in accordance with the invention.

FIG. 11 illustrates a screen shot of an aggregate list of customer data in accordance with the invention.

FIG. 12 illustrates customer data collected from a market survey in accordance with the invention.

FIG. 13 illustrates a report generated in part from collected customer data in accordance with the invention.

### DETAILED DESCRIPTION OF SPECIFIC EMBODIMENTS

The present invention can be implemented in many different ways, and the following discussion will describe selected embodiments of the invention. These embodiments are intended as examples only, and not as an exhaustive list of all forms that the invention can take.

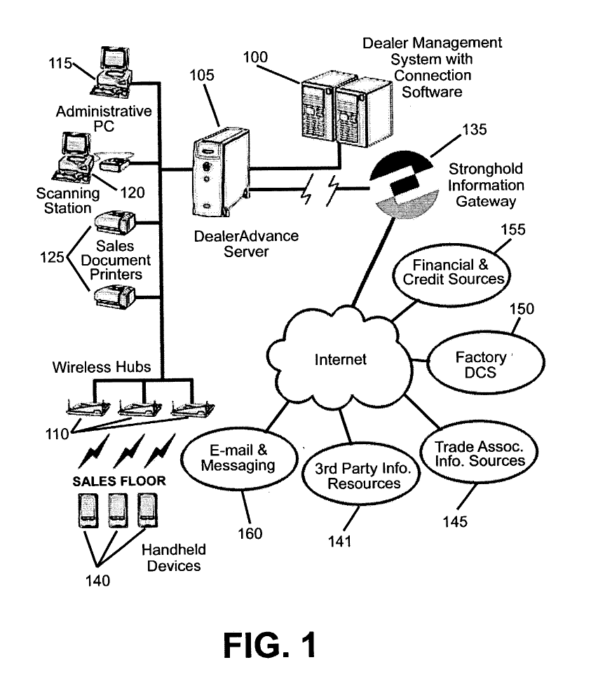

FIG. 1 illustrates an embodiment of a system network architecture in accordance with the invention. The system network architecture includes a management system 100 with connection software in communication with at least one server 105. The at least one server 105 is in communication with at least one wireless access point 110. The at least one server 105 is in communication with at least one of an administrative workstation 115, a scanning station 120 and at least one printer 125. Additional printers can be connected to the server 105 where each additional printer is dedicated to particular tasks and/or particular departments within an automotive dealership. For example, one printer can be dedicated for sales transactions, including printing sales and/or lease forms and another printer can be dedicated for service transactions, including printing work orders and/or repair orders. Moreover, a physical connection or wired connection need not exist between the at least one printer 125 in communication with the at least one server 105. The printer 125 can be a wireless printer worn by a user wherein the wireless printer is in communication with the at least one server 105 through at least one wireless access point 110 or through other wireless technology, such as, for example, Bluetooth or Infrared technologies. The at least one wireless access point 110 is capable of providing either or both a local area and a wide area connection or may be provided by a third party network, such as for example, a cellular service provider. The at least one server 105 is in communication with the World Wide Web and/or the Internet 130 and/or other network node. The communication link between the at least one server and the World Wide Wed and/or the Internet 103 and/or other network node can be provided through a gateway 135.

It should be noted that the system and method of the present invention is not limited to centralized server architecture but is also applicable to a distributed server architecture and FIG. 1 is for illustration purposes only.

The system network architecture of FIG. 1 further includes at least one wireless device 140 in communication with the at least one server 105 through at least one wireless access point 110. The at least one wireless device 140 allows information pertaining customers and/or potential customers to flow from customers and/or potential customers to the dealership and from the dealership to customers and/or potential customers of the dealership at the point of customer contact. Each of the at least one wireless device 140 allows a dealership employee and/or agent to collect data on customers and/or potential customers at the point of customer contact. The collected data can then be put into a database record and used to create a customer profile. The customer profile can then be compared against other database records to provide the dealership employee and/or agent, through the wireless device 140, suggestions, for example, on potential selling opportunities, i.e. products and/or services to suggest to the customer and/or potential customer. The data captured from a customer can provide access to, or an indication of, existing data records relating to the particular customer.

The wireless device can access existing dealership inventory, service capacity and/or an interactive calendar for scheduling customer appointments. Best practices suggestions can be displayed on the wireless device to guide a dealership employee and/or agent through a particular customer interaction. For example, the wireless device can display the steps to follow when taking a customer's car in for service.

According to an embodiment of the present invention databases can be accessed from the wireless device. The databases can be proprietary dealership databases as well as third party databases 141 such as those provided by Chrome Data, in addition to trade association databases 145, manufacturer's databases 150, and financial databases 155, such as credit reporting agencies. World Wide Web and Internet resources, such as CarFax, can be browsed using the wireless device. Additionally, the printing of forms can be initiated from the wireless device. The wireless device of the present invention is also capable of receiving a customer's signature and using the received signature to execute forms and documents. The system and method of the present invention can send and receive e-mail and other messages, such as instant messenger messages to other wired and wireless devices as well as send pages to other wired and wireless devices.

According to an embodiment of the present invention, a dealership employee collects customer and/or potential customer data on the wireless device at the point of customer contact. The dealership employee meeting the customer and/or potential customer on the dealership's showroom floor or car lot can quickly capture customer and/or potential customer data on the spot. The data can be captured by, for example, scanning a magnetic strip on a customer's driver's license or other identification card. The ability to scan a customer's driver license or other identification will also help to prevent fraud. The captured data can then be used to automatically populate data fields of electronic forms or other database records. The ability to pre-populate forms can save between 15 and 20 minutes per customer transaction. Alternatively, the dealership employee may simply record the customer data onto the wireless device through, for example, a keypad, handwriting recognition software, and/or voice recognition software. The customer data once captured on the wireless device can be used to profile the customer or find other instances or records of the same customer in the dealership's databases. A portion or segment of customer data can be used to perform a database query for further information pertaining to the customer. For example, querying a database from the wireless device using just one data field such as the customer's phone number can retrieve an existing customer record inn its entirety for that customer.

If the customer has an existing record or customer profile the information in the record can be used to efficiently serve the customer's needs or provide selling opportunities to the dealership employee. For example, and assuming the dealership is a Toyota dealership, a customer's existing record shows that the customer has made two prior visits to the dealership. The record further comprises a comment indicating that the customer has narrowed his choices down to a new Toyota Corolla and a new Honda Civic. The dealership employee can immediately send a query to a database and obtain side-by-side comparisons for the particular Toyota and Honda models.

Alternatively, assuming the customer and/or potential customer is visiting the dealership for the first time. After the dealership employee has collected customer information, the information can be compared against existing customer data including market studies and analyses of customer data and present selling opportunities to the dealership employee through the wireless device's display based on the comparison.

The captured customer information provides the opportunity for customer and/or potential customer follow-up. The system and method of the present invention allows for a number of follow up tasks to be performed. The tasks can be selected by the employee responsible for initially collecting the customer data or automatically generated by a rules engine that determines which tasks to perform on the customer data based on a set of predefined criteria determined in part by analyses of existing customer data. The follow up may take many forms including a phone call, a letter, and/or e-mail. The follow up may be generic in nature such as a form letter or more targeted and personalized, such as indicating a specific vehicle or an earlier referenced service related issue.

The dealership employees and/or agents can manage their customer contacts directly from the wireless device and access information pertaining to the same in real time. The employees and/or agents can access follow up tasks related to each customer in their contact list and review pending tasks and add tasks as well as substrate pending tasks.

The above discussion is directly applicable to the service side of the automotive dealership. Implementation of the system and method of the present invention in the service side allows service advisors to service customers from the side of their vehicles. For example, a service advisor can scan the vehicle identification number (“VIN”) of the vehicle that is to be serviced. If the dealership has had anything to do with that particular vehicle in the past a record relating to the vehicle and the owner of the vehicle would be returned to the wireless device. If the vehicle is new to the dealership then a new record would have to be created. Alternatively, or in conjunction, the service advisor can query a database from the wireless terminal using the customer's name or license plate number. Based on the customer's profile the wireless device will receive information suggesting services to sell to the customer. In addition, the wireless device may receive information pertaining to factory recalls or other factory campaigns if available. The wireless device can also provide one click functionality that minimizes the data entry efforts of the service advisor. An example of one click functionality includes a “quick lube.” Processing lube paperwork typically requires the service advisor to perform several steps when processing a customer for the service, whereas using the “quick lube” icon reduces the process to one step. Moreover, once the data is entered on the wireless device there is no need for the service advisor to re-enter the data into a legacy database because the data from the wireless device can automatically updates the legacy database. The wireless device can also be process credit and debit card payments and other types of payments. During peak times the service advisor can stack vehicles by scanning multiple vehicles quickly without actually processing individual repair requests which allows the customers to wait in a more controlled environment and/or comfortable environment, such as a lounge. The service advisor can then meet with each customer in the lounge area to complete the repair request. In addition, the service advisor can process any loaner vehicle paper work from the wireless device at the same time he or she processes the repair request. Any paper work relating to the repair request or loaner vehicle can be printed at a stationary printer or a mobile or wireless printer worn or otherwise carried by the service advisor.

The wireless device can also prompt the service advisor with questions to ask a customer in order to focus the area of inquiry for the service technician that receives the repair order or work order. For example, if a customer comes into the dealership with an air conditioner problem, the service advisor can select from the display of the wireless terminal “air conditioning service” and upon selection the service advisor will be prompted with serious of inquiries to make to the customer such “Is the air conditioner not cold enough?”

Additionally, use of the system and method of the present invention as a service tool allows greater realization for in-lane repairs. A percentage of repairs brought to a dealership can be fixed in the service lane, i.e., the area in which customer vehicles are received. For example, replacing a headlight is such an in-lane repair. A technician can replace the headlight without taking the car in for service. For these types of repairs more time is typically spent on the paper work than doing the repair and as such the paper work is not completed or is incomplete and the dealership has no realization for such repairs. The system and method of the present invention provides a quick and easy way to properly record the repair. For example, the data captured using a wireless device pertaining to the customer populates the data fields of the repair order and the appropriate type of repair is checked to allow for the quick and actuate capture of the executed in-lane repair. The available types of permitted in-lane repairs can be customized based on a dealership's own predefined criteria or industry standards.

A wide area modem allows a dealership employee and/or agent to leave the dealership property with a wireless device and go to a customer's home or office and pick up and/or drop off a vehicle. The wireless device provides for the same quick capture of customer data off site as available when the customer brings the vehicle to dealership.

The system and method of the present invention also reduces the time required for a customer to pick up their vehicle from the dealership. For example, customers that are returning to the dealership to pick up their vehicle are greeted by a dealership employee and/or agent, such as a service advisor or lot porter, and after providing their identification to the employee and/or agent which is then captured by a wireless device, the employee and/or agent can review the services performed on the vehicle as displayed on the wireless device display. Upon the customer's satisfactory review of the services performed on the vehicle the wireless device can capture the customer's signature, thereby releasing the vehicle to the customer. Additionally, payments, such as credit or debit cards, and/or warranty claims can be processed using the wireless device.

The system and method of the present invention can also be used to increase the number of selling opportunities. Selling opportunities, also known as up selling, are opportunities to offer products and services to a customer that they may not have come to the dealership originally to obtain. These are opportunities to sell products and services for which a high probability exists, based on a customer profile or other available customer data, that if offered would likely be purchased by the customer in addition to the products and/or services for which the customer originally came to the dealership to obtain. Up selling opportunities can be communicated to the wireless device to the dealership employee and/or agent in the form of prompts and/or a suggested script displayed on the wireless device. Additionally, up selling opportunities can be followed up, at a time subsequent to customer contact, through alternative channels, such as for example, a phone call, mail, and/or email. The actual timing for the follow-up can be scheduled by a rules engine and determined in part by the type of up selling opportunities.

These up selling opportunities include suggesting services required to keep a customer's vehicle in proper running condition, dealer recommended services such as air conditioner services in the summer and radiator flushes in the fall, factory recommended services such as services pertaining to recommendations found in a vehicle owner's manual, and services to be performed in regard to a factory recall.

Reminders could be provided through the wireless device to the employee and/or agent of unsold service opportunities. Alternatively, these reminders can be provided to a workstation. These are products and services offered at a prior occasion but turned down for whatever reason. For example, a dealership may have recommended a repair to the customer on a prior visit and the customer turned down the repair. The employee and/or agent can be reminded of the existence of unsold services and ask the customer again if they would like the service repair performed.

Other opportunities to up sell provided by the use of the present method and system include automatic follow up with customers who have missed estimated scheduled dealership visits, such as 30,000 miles check up, automatic follow up with customers who have turned down service, automatic follow up with customers to confirm appoints a day in advance of the scheduled appointment, printing coupons valid for the customer's next dealership visit, wherein the item covered by the coupon is based on the customer's profile or vehicle history, for example, if a customer comes in for air conditioning service the coupon could be for a radiator flush in the fall.

The method and system of the present invention also supports a dealership rewards program or other dealership VIP programs which in turn provide further opportunities to up sell. A rewards program can offer specialized services to customers who are members of the program and provided they meet the predefined milestones of the program. For example, the dealership may offer a free oil change after every twelfth oil change. A customer's profile can be incremented for each oil change through the wireless device. After the twelfth oil change the customer is notified by the dealership employee and/or agent that their next oil change is free. The employee and/or agent is made aware of this from a review of the customer's profile using the wireless device. The system and method of the present invention takes the responsibility for maintaining records regarding the number of oil changes from the customer and places with the dealership. A rewards program allows the dealership several, in the oil change case at least thirteen; opportunities to up sell additional services and products during each oil change visit.

Rewards programs also include bundling special services with the purchase of a new vehicle from the dealership. For example, a dealership may provide free vehicle washes for the life of the vehicle. However, dealerships only want to offer such services to those customers who have actually purchased the vehicle from them. The system and method of the present invention allows an employee and/or agent of the dealership to collect customer data, for example, by scanning a customer identification card or VIN or VIP tag. The customer profile is displayed on the wireless device and indicates whether or not the customer is eligible for premium services, such as lifetime vehicle cleanings, as a result of buying the vehicle from the dealership. The customer profile could also display whether the vehicle is due for service and if so the service appointment could be scheduled directly from the wireless device at the point of check in for the vehicle cleaning. The premium services keep bringing the customer back to the dealership thereby providing additional opportunities to up sell additional services.

The system and method of the present invention also supports comprehensive management reports for facilitating informed decisions. For example sales management reports enable sales managers to assess media and advertising effectiveness, to track conversion rates by salespersons, monitor existing sales activity, and review data on a salesperson's effectiveness.

The system and method of the present invention is capable of managing inventory through a wireless device. For example, product orders can be placed directly through a wireless device.

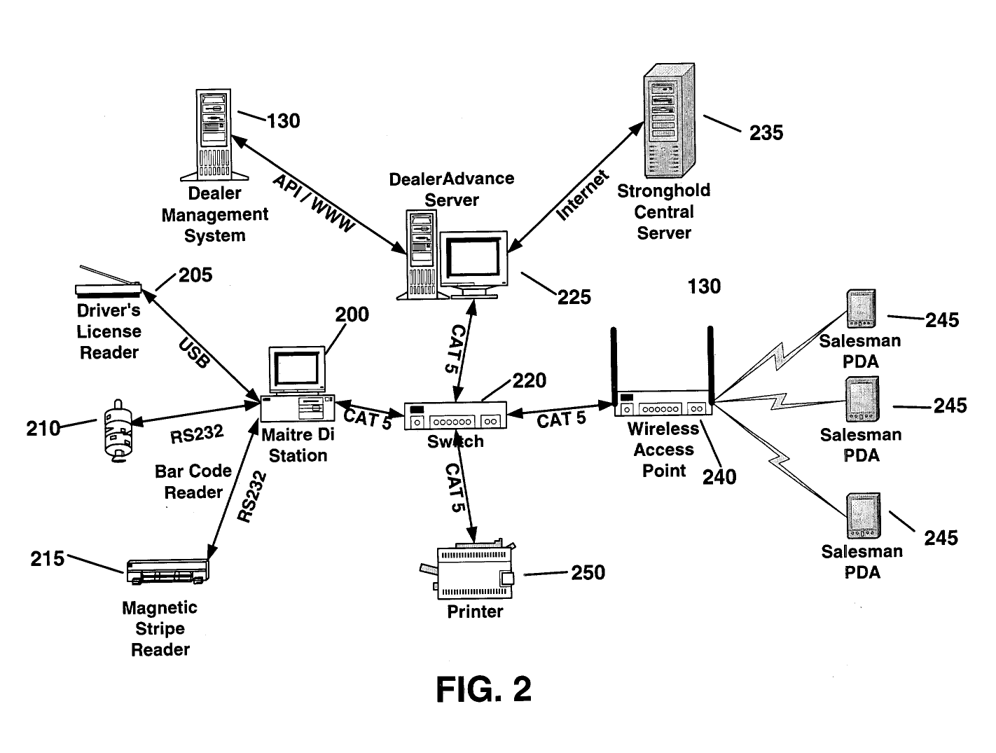

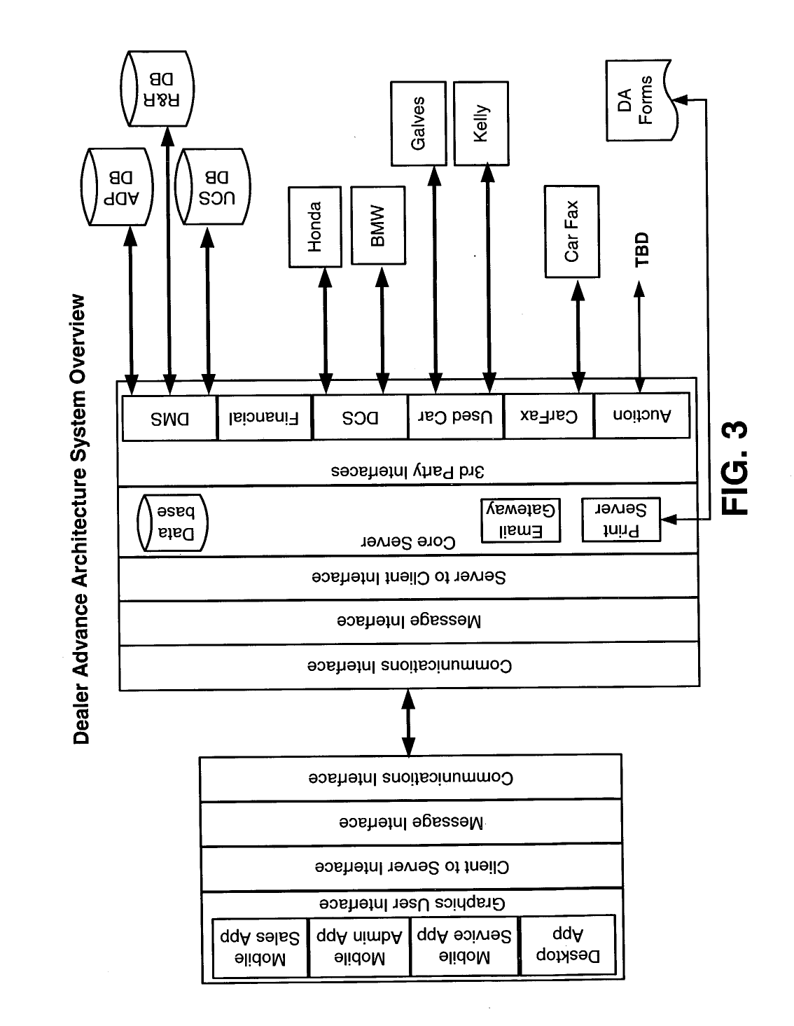

FIG. 2 illustrates an embodiment of a system hardware architecture in accordance with the invention. The embodiment according to FIG. 2 has a maitre de workstation 200 for capturing customer data. Attached to the maitre de workstation 200 is a driver's license reader 205, a bar code reader 210, and a magnetic strip reader 215. The maitre de workstation 200 is connected to a switch 220. The switch 220 is connected to a server 225. The server 225 is in communication with a management system 230 and at least one other server 235. The switch 220 is connected to at least one wireless access point 240. The wireless access point 240 is in communication with at least one wireless device 245. The at least one wireless device 245 can have scanning capability such as Symbol Technologies PDT 8100 wireless device.

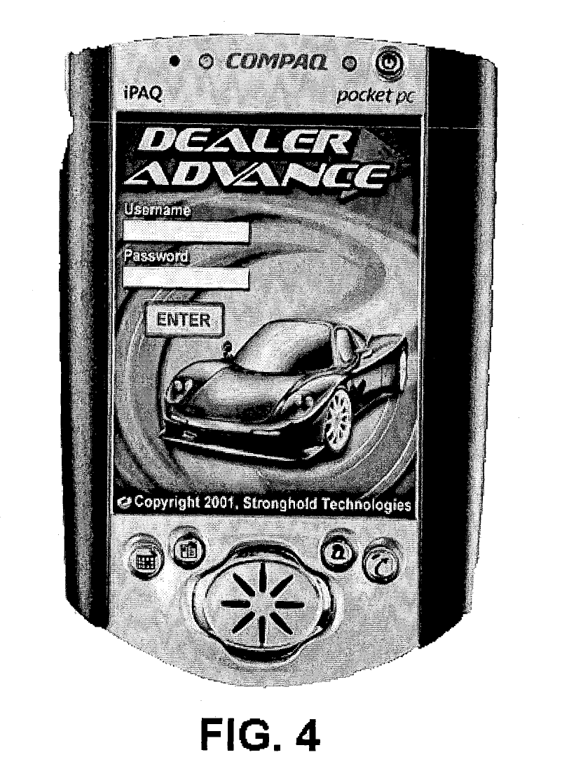

FIG. 4 illustrates an embodiment of a wireless device that can be used in accordance with the invention. The wireless device 300 illustrated is that sold by Compaq under the product name iPaq running an operating system available from Microsoft Corporation. Examples of additional wireless devices that can be used in accordance with the invention include Symbol Technologies PDT 8100 Series Portable Data Terminal with bar code scanning capability and LXE's MX3-CE device. The system and method of the present invention is capable of running a graphical user interface (GUI) which presents menu bars and icons to a user for navigating and drilling down to access either additional menu bars and icons or queried for information. The graphical interface of the present invention can provide menu bars or icons for accessing, for example, prospective customer data, inventory data, product comparisons, credit check data, budgetary calculators, trade in estimates, manager help, e-mail access, forms, and control desk management.

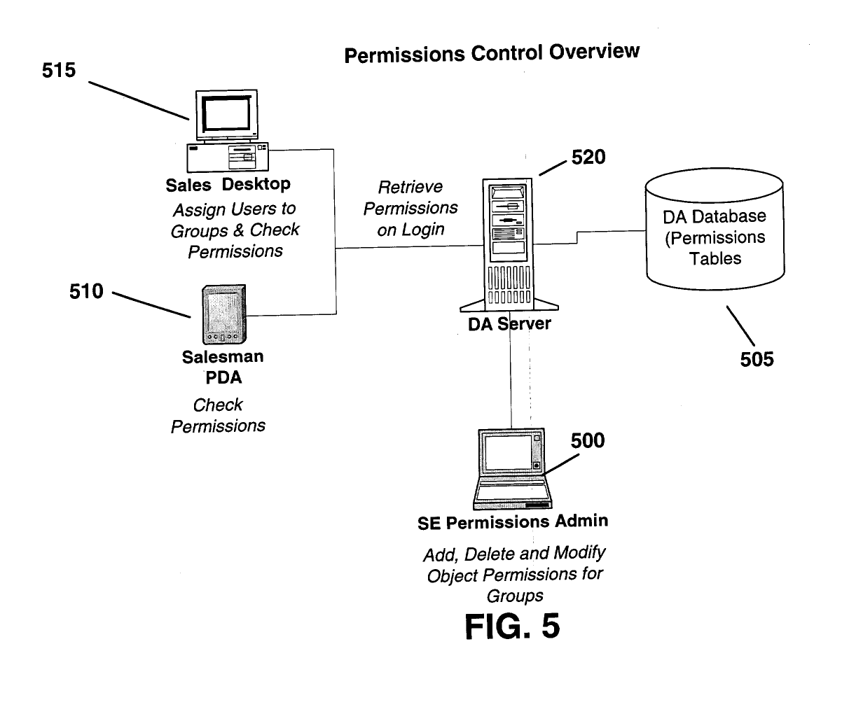

FIG. 5 illustrates an embodiment of a permissions control of a system in accordance with the invention. The permissions control controls user access to system information. Some users may only have permissions to only access their own customer lists. The permissions can be limited to read only barring a user from editing any records. According to this illustration a permissions workstation 500 adds, deletes and modifies object permissions for users of the system based on a users group affiliation. The permissions configuration provided by the permissions workstation 500 are stored in a database 505 in permission tables. When a user, either a wireless device user 510 or a wired device user 515, attempts to access the system server 520 the server checks the user's profile against the permission tables. Access is provided to the system server 520 based on the user's profile.

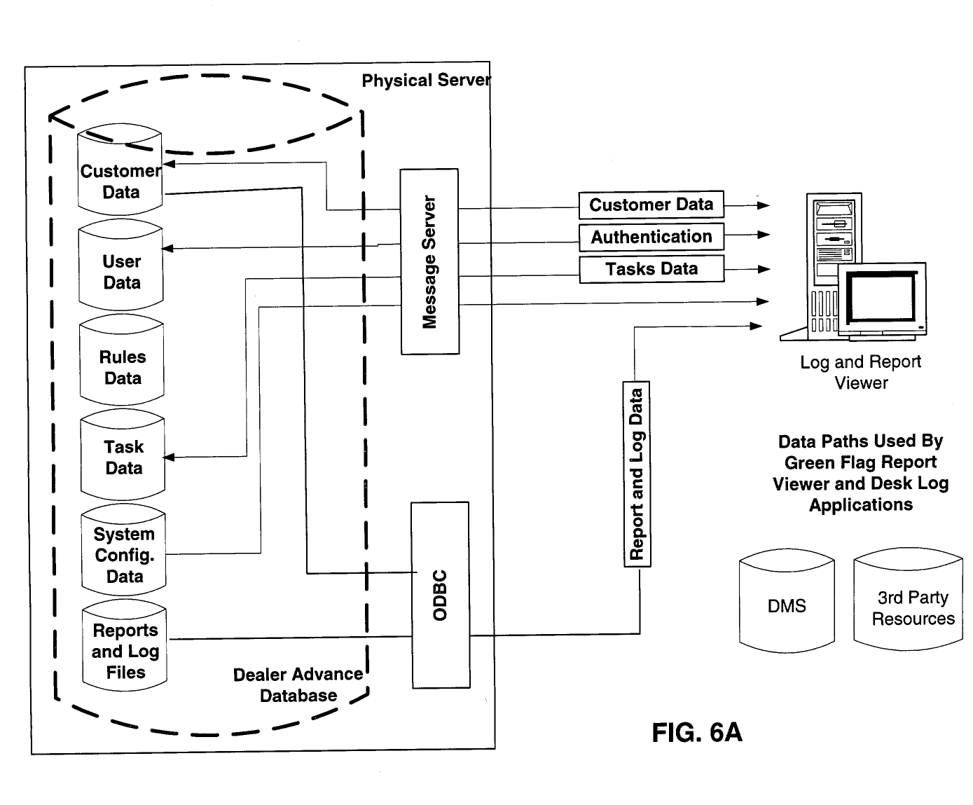

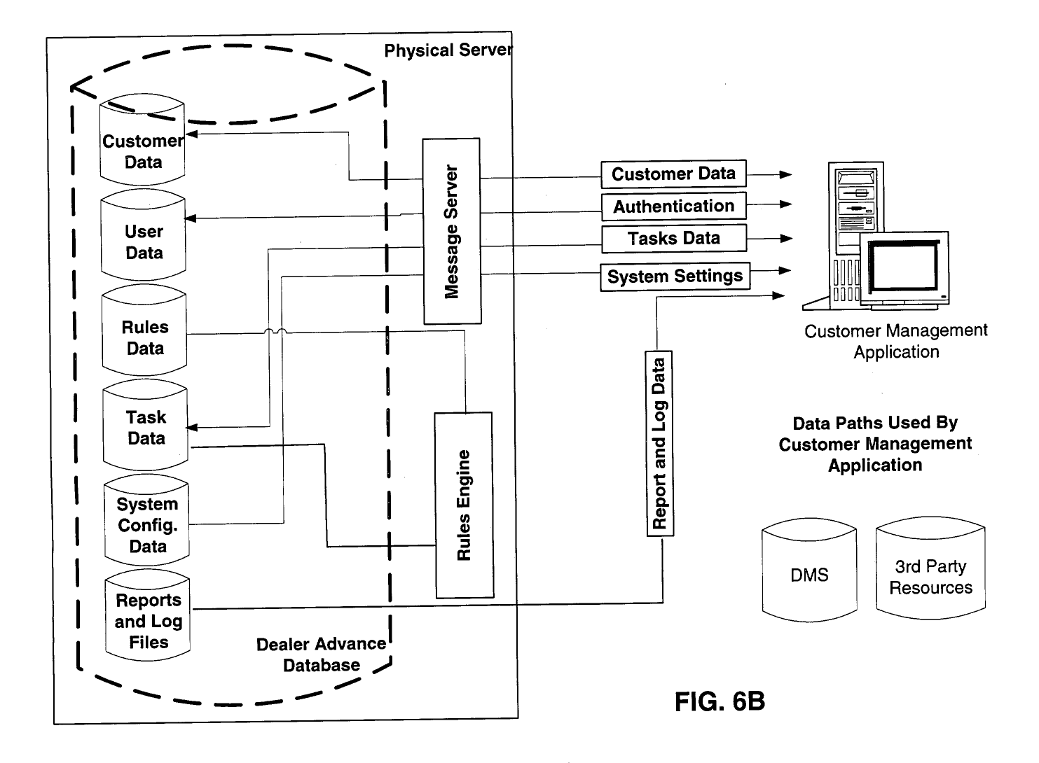

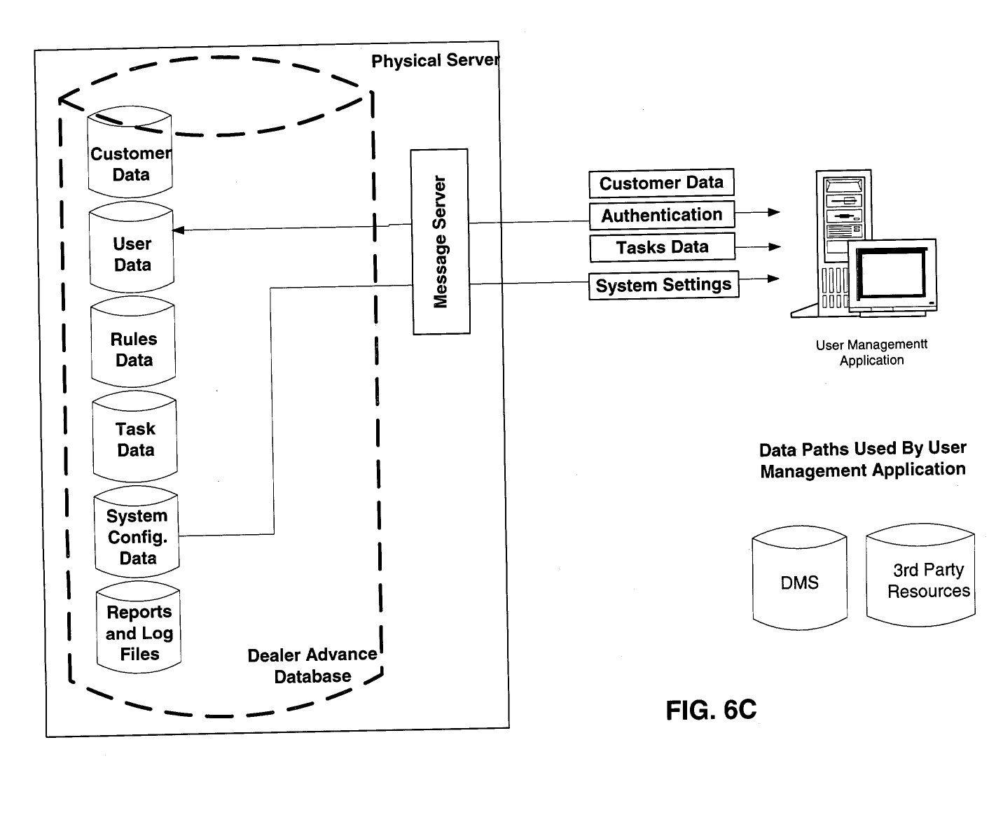

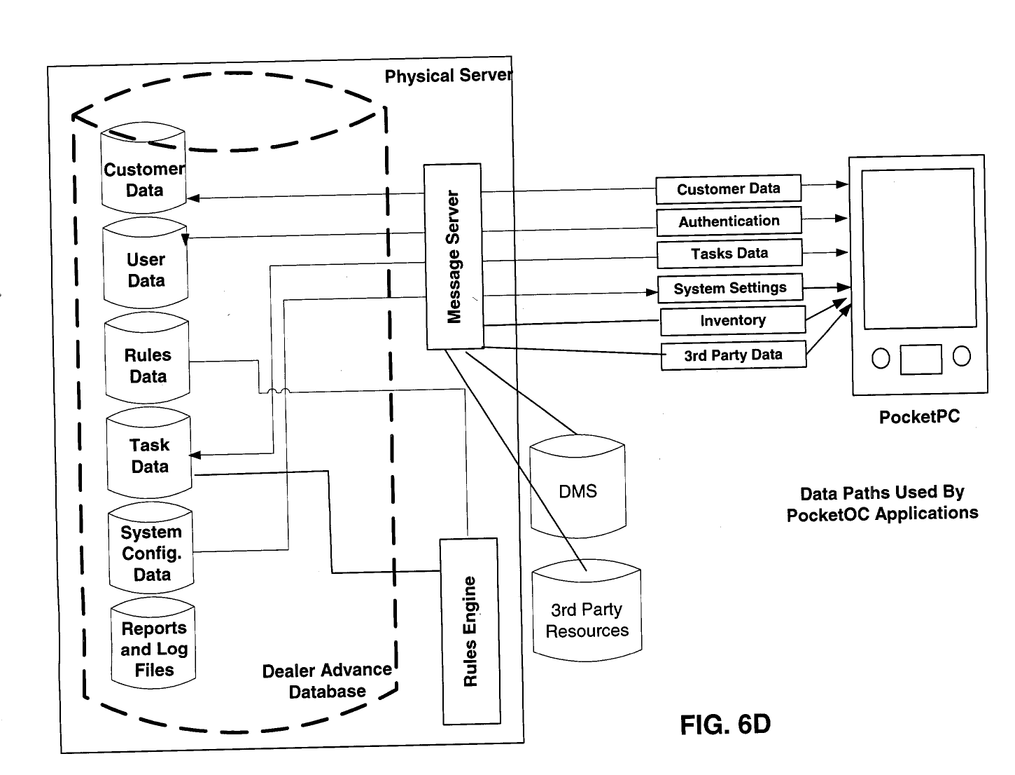

FIG. 6A illustrates an embodiment of data paths used to create document-like formatted reports. FIG. 6B illustrates and embodiment of data paths used to manage and perform tasks on capture customer data. FIG. 6C illustrates an embodiment of data paths used to manage employee and/or agent data. For example the data paths used in FIG. 6C can result in the generation of employee productivity reports. FIG. 6D illustrates an embodiment of data paths used by users of wireless devices to capture customer information and query databases as well as manage and perform tasks on the captured customer information.

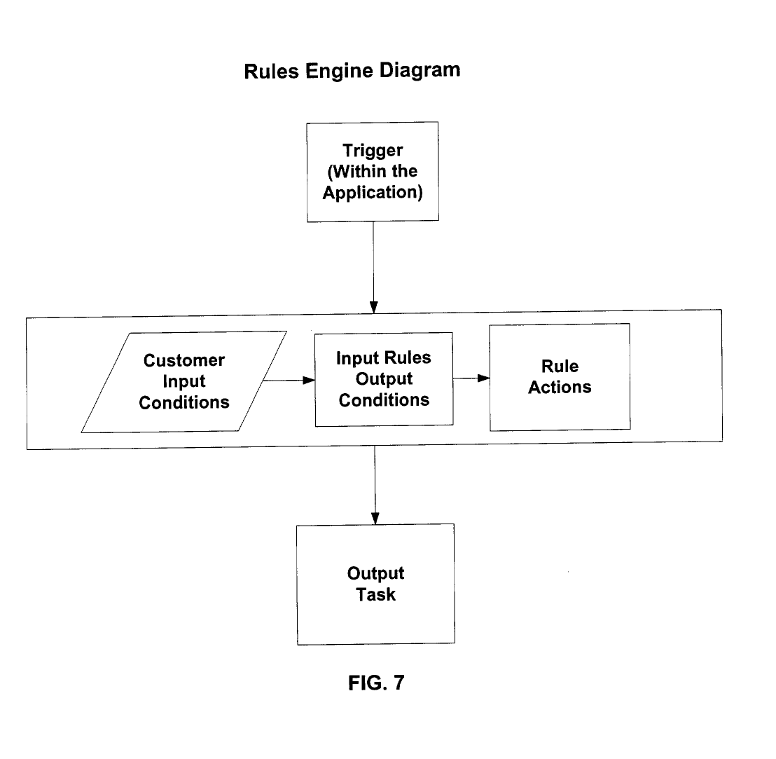

FIG. 7 illustrates a flow chart of a rules engine for scheduling and executing tasks in accordance with the invention. The rules engine generates tasks for the users of the system based on a combination of input conditions, triggers, and rule actions. Input conditions indicate the current state of a customer. Customer state information includes for example, the source of the customer, the customer's current status, the current task being performed on the customer, and a listing of unsold service opportunities. The input conditions may be generated and/or maintained by the system or may be received from external data systems, such as for example, legacy IT systems, factory systems, the Internet, caller identification, and radio frequency identification tags.

A trigger is used to indicate when an event has taken place with the customer and notifies the rules engine to evaluate the current state of the customer. This is essentially an instruction to the system to examine the input conditions again and determine if any output should be generated. Examples of triggers include, for example, adding a new customer, changing a customer's status, completing a task for a customer, and importing customers in to the system. The output generate can be customized to a company's particular business processes. Triggers can be generated based on real time changes or batch changes to the input conditions. Downloading a sold customer list, after hours, from the dealership's legacy IT system would be considered a batch change to the system.

Rules actions dictate how and when a task should be assigned. Rule actions are evaluated on a per task basis after the rules engine generates the task. Rule actions control, for example, who is assigned the task, if the task should be created open or closed, if other tasks should be erase. Each rule action is an independent code module that is processed by the rules engine.

The system has the ability to generate tasks through the rules engine, manual input and/or bulk task generation. Tasks consist of pairs of “task types” and “task modifiers.” A “task types” indicates the category of the task. For example, call, appointment, letter and event are all “task types.” A “task modifier” indicates the specific nature of the task. There can be many “task modifiers” for each “task type.” Customer events are generated as completed tasks. New tasks are generated and are available in real time. The system and method of the present invention is capable of recursive task scheduling. For example, completion of one task can generate another task. Further, tasks can be automatically assigned to different users based on a dealership's predefined business process. For example, managers are prompted to make a confirmation phone call when a salesperson creates an appointment for a customer. Tasks can be scheduled in the past to create customer events. Moreover tasks can be scheduled for the present and the future.

Examples of types of output the rules engine is capable of generation include: generating a task for a user to complete within a specified time period, such as call a customer within a predefined period of time; generating an event that indicates a change in the customer's input conditions, such as when a customer buys a car; notifying the user of additional functions that are required based on the input conditions of the customers, which allows the rules engine to manage very complex arrangements of input conditions and triggers while maintaining a simple user interface and includes upon the completion of a process the user is asked to complete a survey; selecting the appropriate user for a new task, for example tasks can be assigned to a dedicated user, such as all correspondence tasks are assigned to the receptionist, the owner of the customer, the user completing a task, or the user's manager, or to third party resources dedicated to performing follow up tasks such as an outsource call center company. Examples of surveys included at the completion of a task include a new prospective customer wrap up, which generates a survey to be completed by the user that indicates why the customer did not purchase a product and what actions were performed with the customer during the visit; a task wrap up, which generates a survey where the user indicates the actions taken with the customer during a particular interaction such as a phone call or appointment; and sold customer wrap up, which generates a delivery checklist survey allowing the user to indicate that each step of the delivery process was completed and capturing the customer's signature on the wireless device.

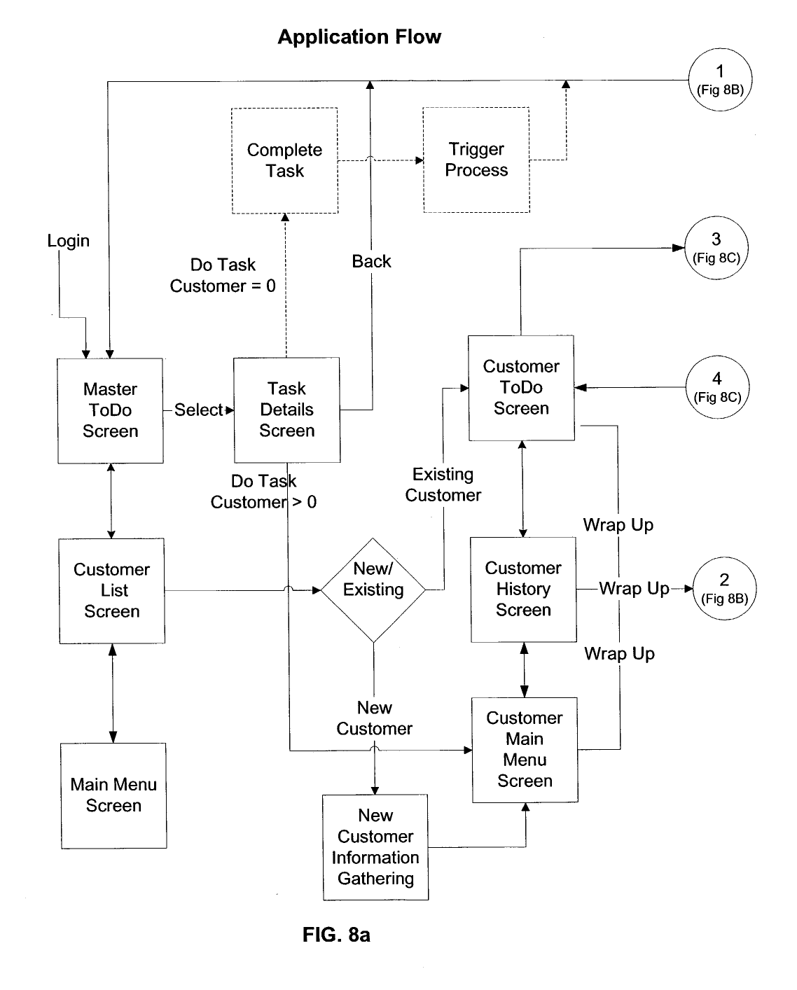

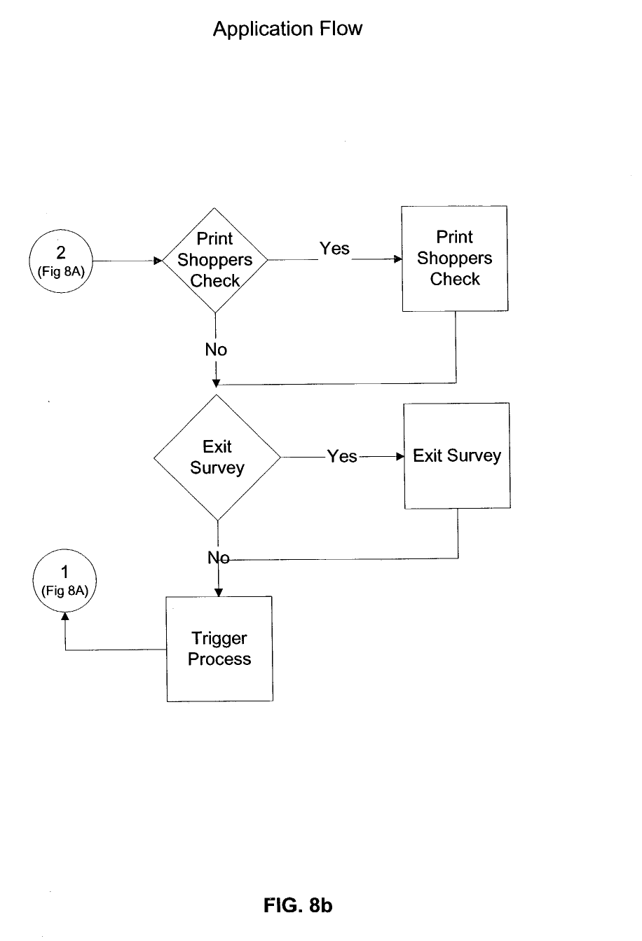

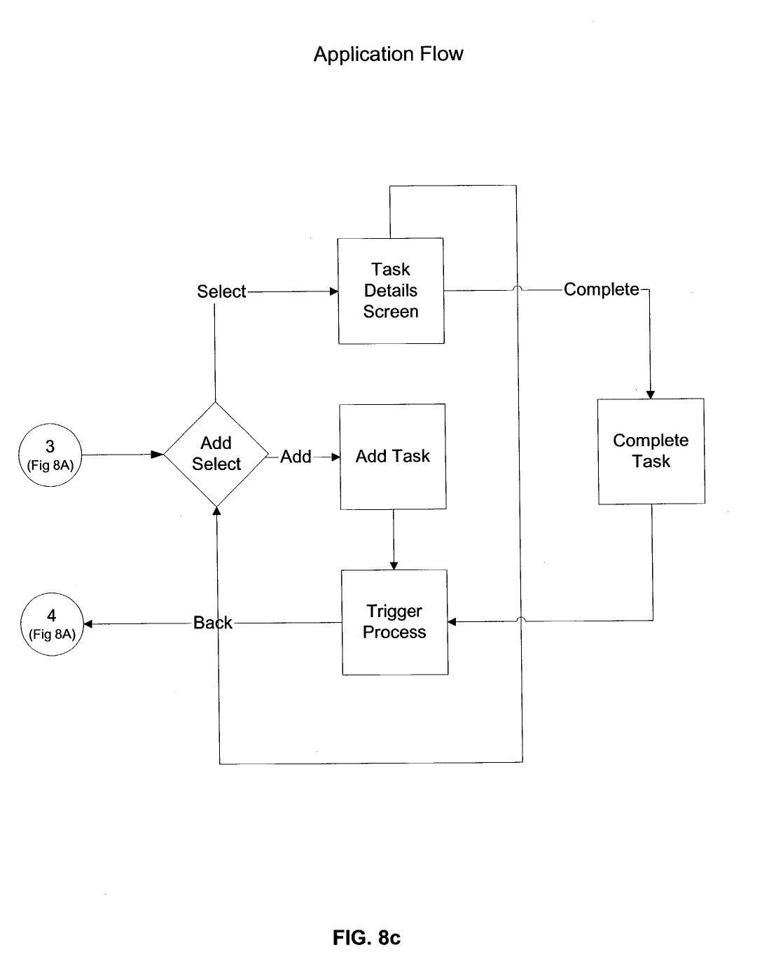

FIG. 8 illustrates a flow chart of an application flow diagram in accordance with the invention.

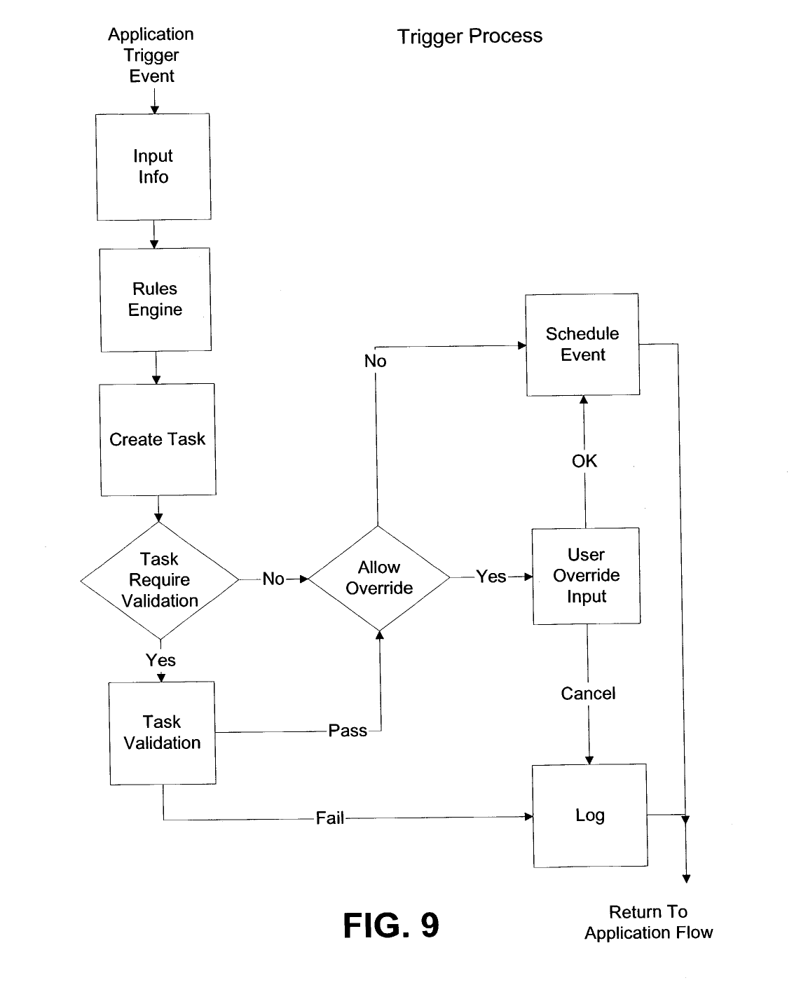

FIG. 9 illustrates a flow chart of a trigger process in accordance with the invention.

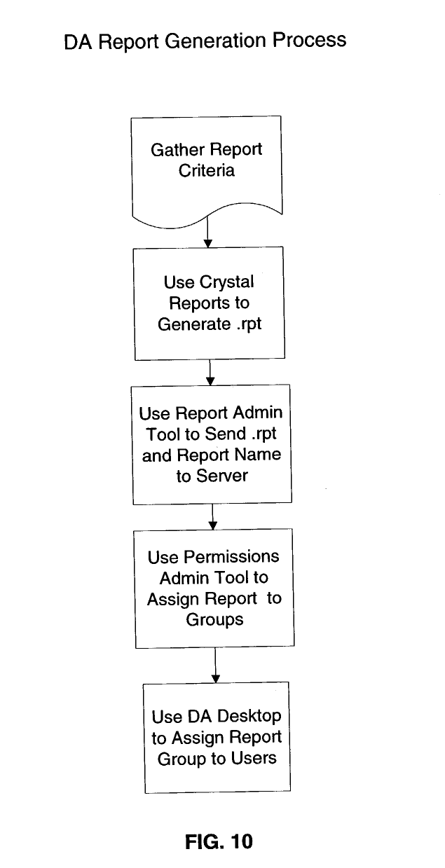

FIG. 10 illustrates a flow chart of a report generation process in accordance with the invention.

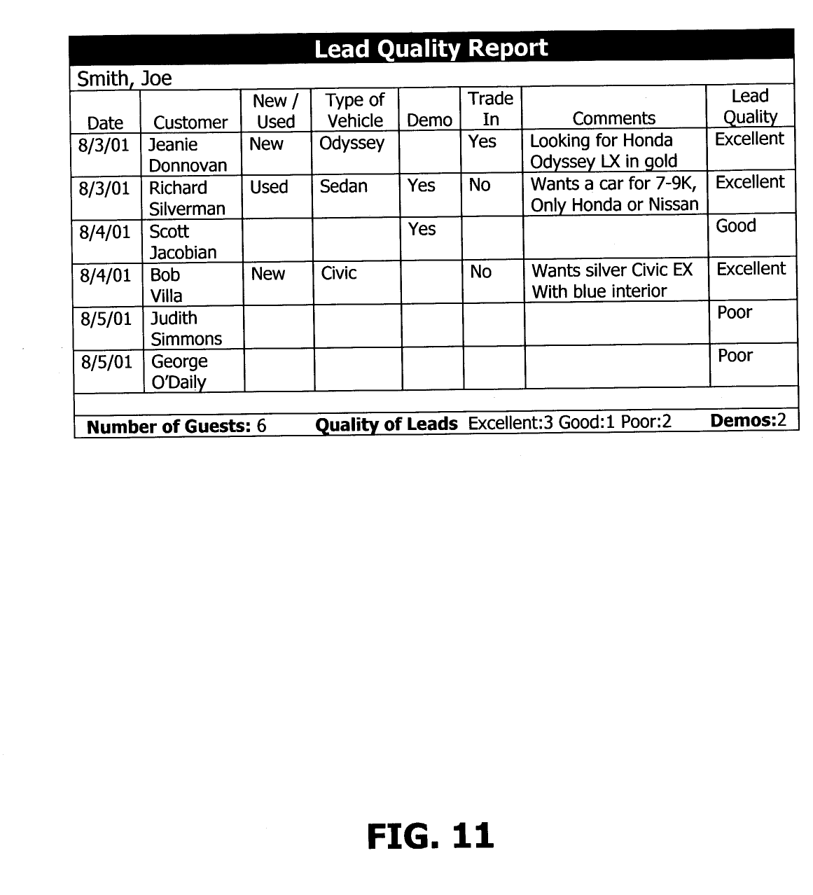

FIG. 11 illustrates a screen shot of aggregate list of customer data in accordance with the invention. Depicted in a list of customer contacts that below to a specific company employee. In this instance Joe Smith received six potential customers during the duration of his business day. The list also indicates the quality of the lead and the type of vehicle the customer is looking for if available. The system and method of the present invention can evaluate the customer data gathered and create performance metrics to rate the follow up potential of a customer. For example, a prospect record that contains a customers name, two contact phone numbers and the type of vehicle the customer desire might be rated as having excellent follow potential.

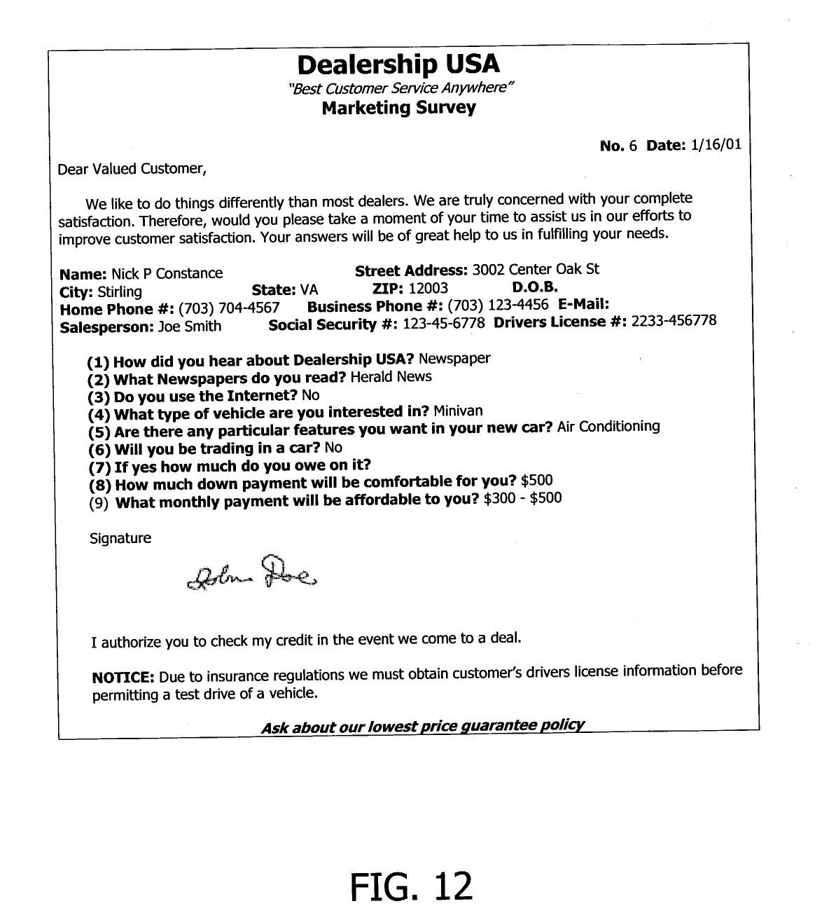

FIG. 12 illustrates the type of customer data that can be collected using a market survey questionnaire. The wireless device also allows the signature of the customer to be digitally captured.

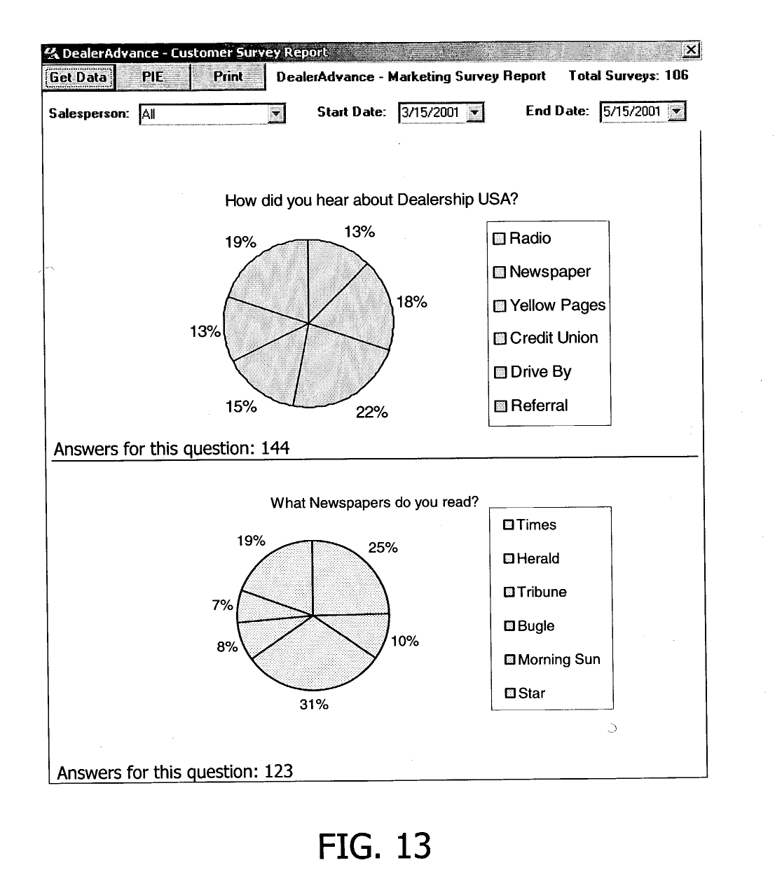

FIG. 13 illustrates an instance of a summary data report for customer data gathered in a marketing survey.

In an alternative embodiment, all the above customer data discussed can be collected using a desktop workstation.

The present invention is not limited to applications involving the processing of medical prescriptions but can be applied to any situation in which a mail order industry desires to decrease its reliance on paper documents and manual document transmittal methods. The various processes and flow charts described herein may be modified and/or sequenced differently. Moreover, the system and method of the present invention can be readily applied to any company independent of the services and products sold.

In general, it should be emphasized that the various components of embodiments of the present invention can be implemented in hardware, software, or a combination thereof. In such embodiments, the various components and steps would be implemented in hardware and/or software to perform the functions of the present invention. Any presently available or future developed computer software language and/or hardware components can be employed in such embodiments of the present invention. For example, at least some of the functionality mentioned above could be implemented using C or C++ programming languages.

Preferred and alternate embodiments of the present invention have now been described in detail. It is so noted, however, that this description of these specific embodiments is merely illustrative of the principles underlying the inventive concept. It is therefore, contemplated that various modifications of the disclosed embodiments will, without departing from the spirit and scope of the invention, be apparent to persons of ordinary skill in the art.

What is claimed is:

1. A system for managing an automotive dealership, wherein all interactions between the automotive dealership and at least one customer of the automotive dealership are captured with a wireless device at the point of customer contact with the automotive dealership; said system comprising:
a wireless device, wherein said wireless device is capable of at least one of
receiving customer data at the point of customer contact with the automotive dealership,
sending at least one query to at least one database; or
displaying at least one of
received customer data,
processed customer data post receipt of customer data received at the point of customer contact, or
queried data from at least one database; and
at least one processing device, wherein said at least one processing device is capable of
processing tasks in response to said customer data

2. The system according to claim 1, further comprising at least one server in communication with said wireless device.

3. The system according to claim 2, further comprising at least one workstation in communication with said server.

4. The system according to claim 1, further comprising a printer in communication with said wireless device.

5. The system according to claim 1, further comprising a scanning device in communication with said wireless device.

6. The system according to claim 1, wherein said wireless device is further capable of scanning customer data.

7. The system according to claim 1, wherein said wireless device further comprises the capability to receive a customer signature.

8. A method for managing an automotive dealership, wherein all interactions between the automotive dealership and at least one customer of the automotive dealership are captured with a wireless device at the point of customer contact with the automotive dealership; said method comprising:
collecting customer data at the point of customer contact with the automotive dealership on a wireless device;
storing said customer data in at least one database;
sending at least one query to at least one database from said wireless device;
displaying on said wireless device at least one received customer data,
processed customer data post receipt of customer data received at the point of customer contact, or
queried data from at least one database;
managing collected customer information from said wireless device; and
processing tasks in response to said customer data.

9. The method according to claim 8, further comprising managing employees of the automotive dealership from said wireless device.

10. The method according to claim 8, further comprising printing forms from said wireless device, wherein said forms comprises data fields that are filled in part automatically with at least one of said customer data or at least one processed task associated with said customer data.

11. The method according to claim 8, further comprising displaying icons on said wireless device, wherein said icons drill down to predefined forms.

12. The method according to claim 8, further comprising receiving a customer signature at said wireless device.

13. The method according to claim 8, further comprising paging at least one other employee of the automotive dealership from said wireless device.

14. The method according to claim 8, further comprising employing a user profile for each employee of the automotive dealership, wherein said user profile determines the level of access to customer data and automotive dealership data.

15. The method according to claim 8, further comprising monitoring transactions of the automotive dealership from said wireless device.

16. The method according to claim 8, further comprising monitoring transactions of the automotive dealership from a workstation.

17. The method according to one of claims 15 and 16, wherein said monitoring is in real time.

18. The method according to one of claims 15 and 16, wherein said monitoring is of all transactions of the automotive dealership.

19. The method according to claim 8, further comprising creating work plans from said wireless device.

20. The method according to claim 8, further comprising providing walk through prescriptions for guiding employees of the automotive dealership through specific dealership tasks.

21. The method according to claim 8, further comprising producing a customized follow up plan for each customer of the automotive dealership, wherein said customized follow up plan is determined from mining said collected customer data.

22. The method according to claim 8, further comprising scanning customer data with said wireless device.

23. The method according to claim 8, further comprising sharing data between two automotive dealerships, wherein said sharing of data takes place from the wireless device.

24. The method according to claim 8, further comprising displaying icons on the wireless device, wherein said icons represent available actions.

25. The method according to claim 8, further comprising evaluating customer data and establishing specific metrics to rate the follow up potential of a customer.

26. The method according to claim 8, further comprising monitoring whether a customer is handled according to automotive dealership defined parameters.

27. The method according to claim 8, wherein the step of processing tasks associated with said received customer data is recursive.

28. The method according to claim 8, wherein the step of processing tasks associated with said received customer data determines which actions are to be taken by the automotive dealership.

29. The method according to claim 8, further comprising creating at least one of a work order a repair order, a customer appointment, or a request for a loaner vehicle from said wireless device.

30. The method according to claim 8, wherein said query send to at least one database is a customer phone number.

31. The method according to claim 8, further comprising recommending at least one of services or products to at least one customer based at least one of a previous visit to the dealership or the vehicle make, model, mileage, and history with the dealership.

32. The method according to claim 31, wherein at least one of services or products are recommending to said at least one customer based on a determination made by a predefined set of rules.

33. The method according to claim 8, wherein the point of customer contact includes at least one of an automotive dealership vehicle lot, an automotive dealership tent sale, vehicle side check-in for service, vehicle pick-up from a customer location, or at point of receipt of inventory.

34. The method according to claim 8, wherein said processed customer data post receipt of customer data at point of customer contact comprises the customer's current points earned to date in a rewards program sponsored by said automotive dealership.

35. The method according to claim 8, further comprising completing all necessary data fields for processing a service request, wherein said step of completing all necessary data fields is done in response to only a single action being performed by a user.

36. A method for managing an automotive dealership from a wireless device comprising:
receiving customer data from a wireless device;
storing said customer data in at least one database;
processing said customer data with a predefined set of rules;
mining said customer data for selling opportunities; and
sending said selling opportunities to said wireless device.

37. A method for managing the productivity of at least one employee of an automotive dealership comprising:
receiving customer data originating from each of said at least one employee, wherein said customer data is collected using a wireless device at the point of customer contact with the automotive dealership;
aggregating customer data received from a plurality of customers from each of said at least one employee into at least one data array, wherein said at least one data array comprises at least one field conveying in real time a performance metric.

38. The method according to claim 37, further comprising allocating resources of said automotive dealership based on said at least one data array.

39. A computer readable media, capable of storing instructions for executing the steps of:
receiving customer data from a wireless device;
storing said customer data in at least one database;
processing said customer data with a predefined set of rules;
mining said customer data for selling opportunities; and
sending said selling opportunities to said wireless device.
